(19) United States
(12) Patent Application Publication
(10) Pub. No.: US 2009/0108908 A1
(43) Pub. Date: Apr. 30, 2009

(54) BOOTSTRAP CIRCUIT AND STEP-DOWN CONVERTER USING SAME

(75) Inventor: Masayuki YAMADAYA, Matsumoto City (JP)

Correspondence Address: ROSSI, KIMMS & McDOWELL LLP., 20609 Gordon Park Square, Suite 150, Ashburn, VA, 20147, US

(73) Assignee: FUJI ELECTRIC DEVICE TECHNOLOGY CO., LTD., Tokyo (JP)

(21) Appl. No.: 12/257,315

(22) Filed: Oct. 23, 2008

(30) Foreign Application Priority Data
Oct. 24, 2007 (JP) 2007-277022

(51) Int. Cl. H02M 3/158

(52) U.S. Cl. 327/390

(57) ABSTRACT

The invention provides a bootstrap circuit which enables adequate charging of a capacitor used in the bootstrap circuit even during light load or no load conditions, and which does not impede the performance of a step-down converter proper, as well as a step-down converter using the bootstrap circuit. A capacitor charge/discharge path formation mechanism is provided in the bootstrap circuit that enables a terminal of a capacitor used in the bootstrap circuit to be separated and made independent from a step-down converter circuit.

### BACKGROUND OF THE INVENTION

The invention relates to a bootstrap circuit which, in order to perform switching control by applying a voltage from a driver to a gate of a switching device which uses an N-channel MOSFET having a drain to which an input voltage is supplied, has a capacitor which steps up a power supply voltage of the driver to the input voltage or higher, as well as a step-down converter using this circuit, and in particular this invention enables adequate charging of a capacitor used in a bootstrap circuit even during light load or no load.

In a step-down converter (step-down type DC-DC converter) which uses an N-channel MOSFET as a switching device, a circuit (generally called a bootstrap circuit), having a capacitor which steps up the power supply voltage of the driver to the input voltage for input to the switching device or higher, in order to apply the high-side driver voltage to the gate of the switching device and perform switching control, is necessary. FIG. 3A through FIG. 3C are diagrams which explain the configuration and operation of a step-down converter comprising a bootstrap circuit of the prior art. In general, a step-down converter drives a driver (Q1 driver) 12 according to a PWM (Pulse Width Modulation) signal 11, as shown in FIG. 3A, and by supplying an inductor current I_{L} to the inductance L₁ (15) from the input voltage VCC during the on interval of the switching device Q₁ (13), energy is stored in the inductance L₁ (15), and the stored energy is discharged to the load, via the path of ground potential→inductance L₁ (15)→load during the off interval of the switching device Q₁ (13) (hereafter, this circuit is called a “step-down converter circuit”), to realize a step-down converter. Here, the diode D₁ (14) (in FIG. 4A described below, the on-state switch Qs (23), or a PN junction diode 24 fabricated by semiconductor processes when manufacturing the switch Qs (23)) provides a current path for current to flow from the inductance L₁ (15) to the load during the off intervals of the switching device Q₁ (13). The capacitor 16 functions as a smoothing capacitor to smooth the output voltage.

As shown in FIG. 3A, a bootstrap circuit 10 of the prior art comprises a power supply VREG (2), diode D_{B} (4), and capacitor C_{B} (6); the capacitor C_{B} (6) used in the bootstrap circuit is charged by current I_{CB} from the power supply VREG (2) via the diode D_{B} (4). The bootstrap circuit 10 is used as a power supply by the driver (Q1 driver) 12 which operates the high-side switching device Q₁ (13), and by driving the driver (Q1 driver) 12 according to PWM signals 11, on/off control of the switching device Q₁ (13) is executed to realize a step-down converter. FIG. 3B explains operation of the step-down converter shown in FIG. 3A during intervals in which the switching device Q₁ is on, and FIG. 3C explains operation during intervals in which the switching device Q₁ is off.

When, as shown in FIG. 3C, the N-channel MOSFET Q₁ (13) is turned off, the capacitor C_{B} (16) used in the bootstrap circuit is charged by the current I_{CB} from the power supply VREG (2), via the diode D_{B} (4). On the other hand, when as in FIG. 3B the N-channel MOSFET Q₁ (13) is turned on, the voltage (VREG-VFB) (where VFB is the forward-direction voltage of the diode D_{B} (4)) across the capacitor C_{B} (6) used in the bootstrap circuit, added to the input voltage VCC (VREG−VFB+VCC), is used to drive the high-side driver (Q1 driver) 12, to perform switching control of the N-channel MOSFET Q₁ (13). This bootstrap circuit can operate on the same principle in the conventional synchronous rectification-type step-down converter shown in FIG. 4A through FIG. 4C, or in the conventional diode rectification-type step-down converter shown in FIG. 5A through FIG. 5C.

When charging the capacitor C_{B} (6) used in the bootstrap circuit in the circuit shown in FIG. 3A or FIG. 4A, first D₁ (14) in FIG. 3A or Qs (23) or the PN junction diode 24 in FIG. 4A must be made conducting, and the potential at the CB-terminal must be set to GND level (strictly speaking, the voltage shifted from GND level by the voltage drop of D₁ (14), the PN junction diode 24, or Qs (23)) and fixed. Further, when there is light load or no load, the load current Io decreases, and even when the diode D₁ (14) is conducting during the off interval of the switching device Q₁ (13) in FIG. 3C, an adequate charging current I_{CB} can no longer be secured. That is, the charging current I_{CB} is a portion of the inductor current I_{L} (I_{CB}<I_{L}), and the average value of the inductor current I_{L} is equal to the average value of the load current Io, so that when the load current Io is small, the charging current I_{CB} can no longer be made large. Also, when the inductor current I_{L} becomes zero, the CB-terminal cannot be held at GND potential, so that the capacitor C_{B} (6) cannot be charged adequately, the charged voltage of the capacitor C_{B} (6) used in the bootstrap circuit falls, and ultimately the switching device Q₁ (13) can no longer be driven. Hence a circuit is also necessary to avoid insufficient charging of the capacitor C_{B} (6) used in the bootstrap circuit.

FIG. 4A through FIG. 4C explain the configuration and operation of a synchronous rectification-type step-down converter comprising a bootstrap circuit of the prior art. FIG. 4A shows the configuration of the synchronous rectification-type step-down converter comprising the conventional bootstrap circuit, FIG. 4B explains operation during intervals in which the switching device Q₁ is on in the synchronous rectification-type step-down converter shown in FIG. 4A, and FIG. 4C explains operation during intervals in which the switching device Q₁ is off. FIG. 4A through FIG. 4C are graphs equivalent to FIG. 3A through FIG. 3C respectively, and the configuration and operation are the same other than for the portions of the switch Qs (23) and the diode D₁ (14).

In the synchronous rectification-type step-down converter of FIG. 4A through FIG. 4C, during no load or light load, a reverse inductor current I_{L} flows during an interval in which the switching device Q₁ (13) is off, worsened efficiency may result, and so it is necessary to detect reverse flow of the inductor current I_{L} and cut off the switch Qs (23) on the synchronous rectification side. However, when such a cutoff function is added, if the load current Io is very small, then the current charging the capacitor C_{B} (6) used in the bootstrap circuit is limited by the inductor current I_{L} in the intervals in which the switching device Q₁ (13) is off and moreover the synchronous rectification-side switch Qs (23) is on, and so similarly to the case of FIG. 3C, the capacitor C_{B} (6) used in the bootstrap circuit can no longer be charged. Therefore, in general control of the switch Qs (23) is executed such that the flow of the inductor current I_{L} is intentionally reversed, as shown in FIG. 4C, during an interval sufficient to enable charging of the capacitor C_{B} (6) used in the bootstrap circuit. As an example of this type of technique of the prior art, for example, the circuit described in the Specification of U.S. Pat. No. 6,747,441 is known. That is, as indicated in FIG. 4 and FIG. 5 of U.S. Pat. No. 6,747,441, the low-side transistor permits reverse flow of current to secure a time period for charging the capacitor 76 of the bootstrap circuit.

FIG. 5A through FIG. 5C explain the configuration and operation of a diode rectification-type step-down converter comprising a bootstrap circuit of the prior art. FIG. 5A shows the configuration of another diode rectification-type step-down converter comprising a bootstrap circuit of the prior art; FIG. 5B explains operation of the diode rectification-type step-down converter shown in FIG. 5A during an interval in which the switching device Q₁ is turned on; and FIG. 5C explains operation during an interval in which the switching device Q₁ is turned off. FIG. 5A through FIG. 5C are equivalent to FIG. 3A through FIG. 3C, respectively, and other than the switch Q_{B} (33) and the driver thereof (Q_{B} driver) 32, the configuration and operation are the same. In contrast with the synchronous rectification design in FIG. 4A through FIG. 4C, in the case of the diode rectification-type step-down converter of FIG. 5A through FIG. 5C, to the CB-terminal of the capacitor C_{B} (6) used in the bootstrap circuit are added a switch Q_{B} (33) and a driver therefor (Q_{B} driver) 32, to connect the CB-terminal to ground in order to secure a current path during charging. By this means, similarly to the principle of synchronous rectification of FIG. 4A through FIG. 4C, by turning the switch Q_{B} (33) on during intervals in which the switching device Q₁ (13) is off, as shown in FIG. 5C, charging of the capacitor C_{B} (6) used in the bootstrap circuit is made possible, even when there is no inductor current I_{L}. As an example of the prior art of this type, for example, the circuit described in U.S. Pat. No. 6,798,269 is known. That is, the switch Qs shown in FIG. 6 of U.S. Pat. No. 6,798,269 is equivalent to the switch Q_{B} of FIG. 5A through FIG. 5C, and similarly to the switch Q_{B} of FIG. 5A through FIG. 5C, by turning the switch Qs on during intervals in which the switching device Q is off, charging of the capacitor C_{B} used in the bootstrap circuit is possible even when there is no inductor current.

Further, in the prior art step-down converters comprising a bootstrap circuit such as that described in Japanese Patent Laid-open No. 10-56776 are known. That is, in a step-down converter comprising a bootstrap circuit described in Japanese Patent Laid-open No. 10-56776, when loading becomes light, the switching frequency is lowered and time to charge the capacitor used in the bootstrap circuit is secured.

Because during light load or no load of step-down converters of the prior art, including those of the above-described U.S. Pat. No. 6,747,441 and U.S. Pat. No. 6,798,269, the capacitor C_{B} used in the bootstrap circuit is charged, during off intervals of the switching device Q₁ control is executed to turn on switch QS in a synchronous rectification-type device and to turn on switch Q_{B} in a diode rectification-type device. In this case, by changing the source-side potential of the switching device Q₁, that is, by changing the inductor current, the current path of the step-down converter itself is affected, so that compared with the step-down converter proper without a bootstrap circuit, power supply efficiency worsening, increases in output ripple, and other side-effects occur, and so there is the problem that the performance of the step-down converter proper is impeded.

In control during light load of the step-down converter in the above-described Japanese Patent Laid-open No. 10-56776, because the ratio of the time during which the capacitor is being charged to the time during which the capacitor cannot be charged does not change, the average charged voltage remains low. During light load, the charging time is lengthened to a certain extent, so that instantaneous driving capacity can be secured, but on the other hand, because the time during which charging is not possible (that is, the discharge interval) is also lengthened, the charged voltage falls immediately, and as the frequency is lowered, there is the problem that the time over which driving capacity is insufficient is also longer.

### SUMMARY OF THE INVENTION

The invention provides a bootstrap circuit which enables adequate charging of the capacitor used in the bootstrap circuit even during light load or no load, and which does not impede the performance of the step-down converter proper, as well as a step-down converter using such a circuit.

In a preferred embodiment, a bootstrap circuit in accordance with the invention, having a capacitor which steps up a power supply voltage of a driver to an input voltage or higher, in order to perform switching control by applying a voltage from the driver to a gate of a switching device employing an N-channel MOSFET having a drain to which the input voltage is supplied, includes a capacitor charge/discharge path formation mechanism, which forms, independently of a step-down converter circuit, a charge/discharge path for charging the capacitor in synchronization with an off state of the switching device, and for discharging the capacitor in synchronization with an on state of the switching device for application as the power supply voltage to the driver.

In a bootstrap circuit of this invention, the CB-terminal of the capacitor C_{B} used in the bootstrap circuit is connected, via the capacitor charge/discharge path formation means, to the step-down converter circuit, and by this means the path for charging the capacitor C_{B} used in the bootstrap circuit is made independent. As a result, effects on the step-down converter during charging of the capacitor C_{B}, that is, the occurrence of power supply efficiency worsening, increases in output ripple, and other side effects, can be avoided. Moreover, the capacitor C_{B} used in the bootstrap circuit can always be charged with stability, regardless of the load state, such as for example when the load is light or there is no load.

Further, a step-down converter including a bootstrap circuit of this invention includes a bootstrap circuit having capacitor charge/discharge path formation mechanism; the CB-terminal of the capacitor C_{B} used in the bootstrap circuit is connected, via the capacitor charge/discharge path formation mechanism, to the step-down converter circuit, and by this mechanism the current path to charge the capacitor C_{B} used in the bootstrap circuit is made independent. As a result, effects on the step-down converter during charging of the capacitor C_{B}, that is, the occurrence of power supply efficiency worsening, increases in output ripple, and other side effects, can be avoided, so that stable operation and improved power supply efficiency of the step-down converter circuit can be expected. Moreover, the capacitor C_{B} used in the bootstrap circuit can always be charged with stability, regardless of the load state, such as for example when the load is light or there is no load.

### BRIEF DESCRIPTION OF THE DRAWINGS

The invention will now be described with reference to certain preferred embodiments thereof and the accompanying drawings, wherein:

FIG. 1A shows the configuration of a first embodiment of a step-down converter comprising a bootstrap circuit of an aspect of the invention;

FIG. 1B explains operation during on intervals of a switching device Q₁ in the step-down converter of the first embodiment shown in FIG. 1A;

FIG. 1C explains operation during off intervals of the switching device Q₁ in the step-down converter of the first embodiment shown in FIG. 1A;

FIG. 2A shows the configuration of a second embodiment of a step-down converter comprising a bootstrap circuit of an aspect of the invention;

FIG. 2B explains operation during on intervals of a switching device Q1 in the step-down converter of the second embodiment shown in FIG. 2A;

FIG. 2C explains operation during off intervals of the switching device Q1 in the step-down converter of the second embodiment shown in FIG. 2A;

FIG. 3A shows the general configuration of a step-down converter comprising a bootstrap circuit of the prior art;

FIG. 3B explains operation during on intervals of a switching device Q1 in the step-down converter shown in FIG. 3A;

FIG. 3C explains operation during off intervals of the switching device Q1 in the step-down converter shown in FIG. 3A;

FIG. 4A shows the configuration of a synchronous rectification-type step-down converter comprising a bootstrap circuit of the prior art;

FIG. 4B explains operation during on intervals of a switching device Q1 in the synchronous rectification-type step-down converter shown in FIG. 4A;

FIG. 4C explains operation during off intervals of the switching device Q1 in the synchronous rectification-type step-down converter shown in FIG. 4A;

FIG. 5A shows the configuration of a diode rectification-type step-down converter comprising a bootstrap circuit of the prior art;

FIG. 5B explains operation during on intervals of a switching device Q1 in the diode rectification-type step-down converter shown in FIG. 5A; and,

FIG. 5C explains operation during off intervals of the switching device Q1 in the diode rectification-type step-down converter shown in FIG. 5A.

### DESCRIPTION OF THE PREFERRED EMBODIMENTS

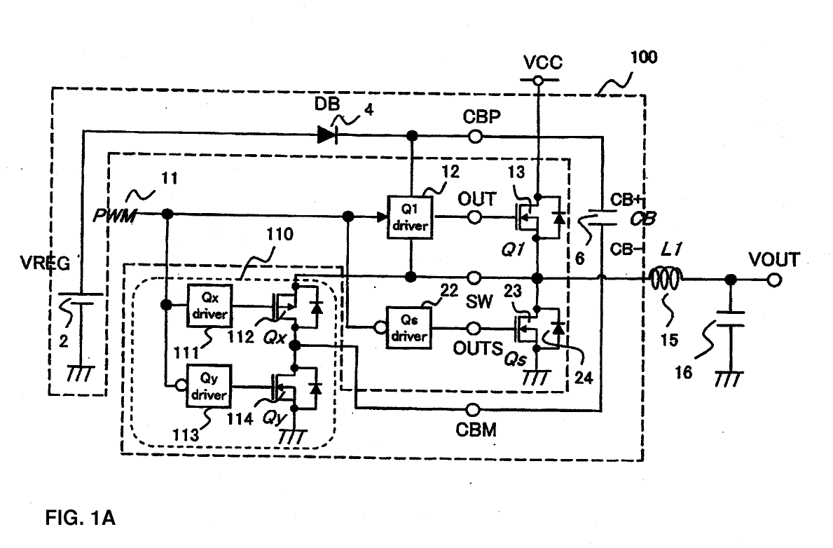

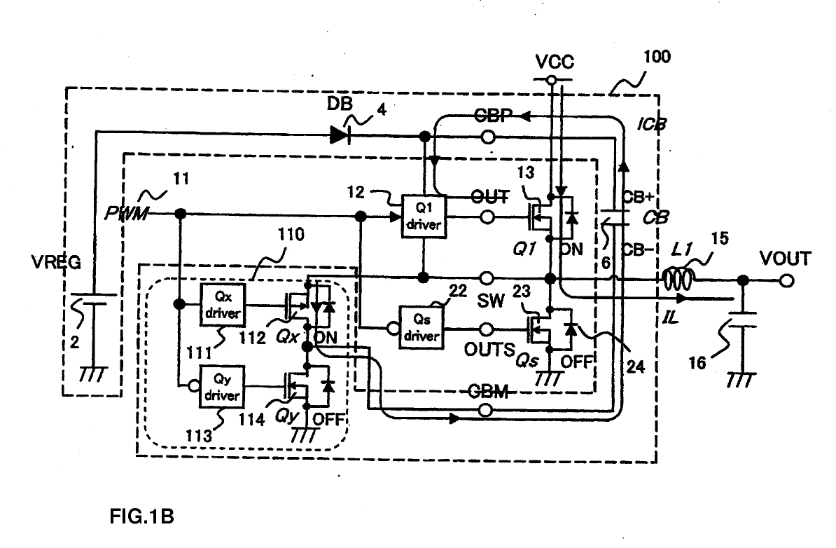

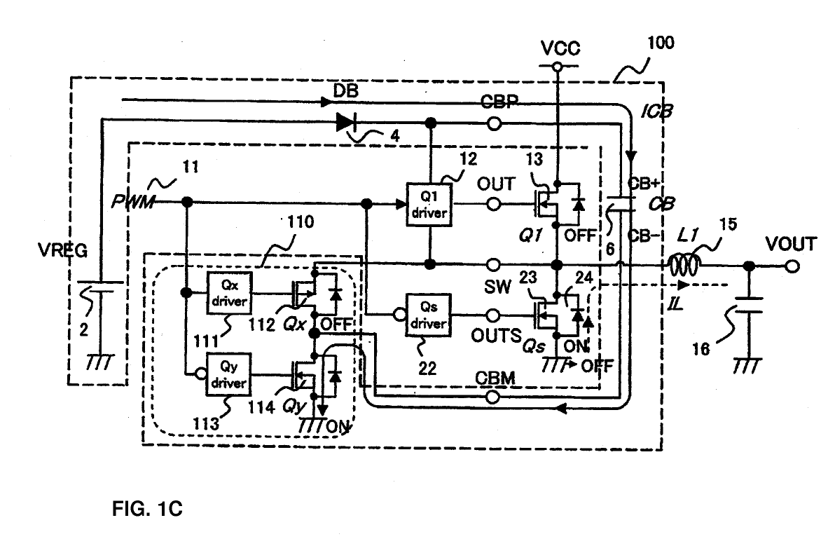

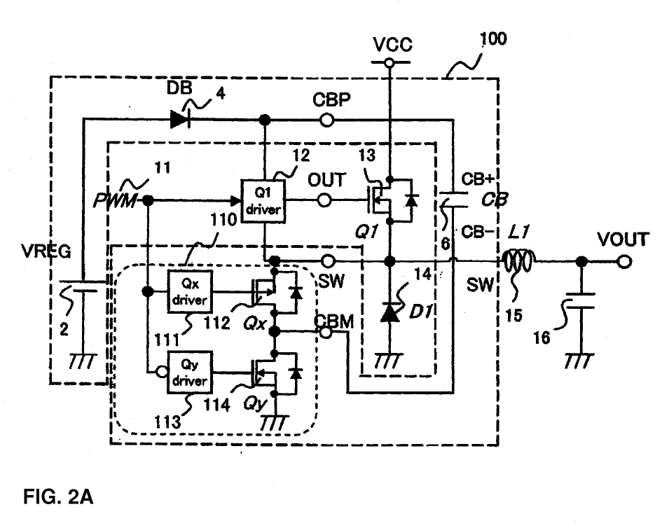

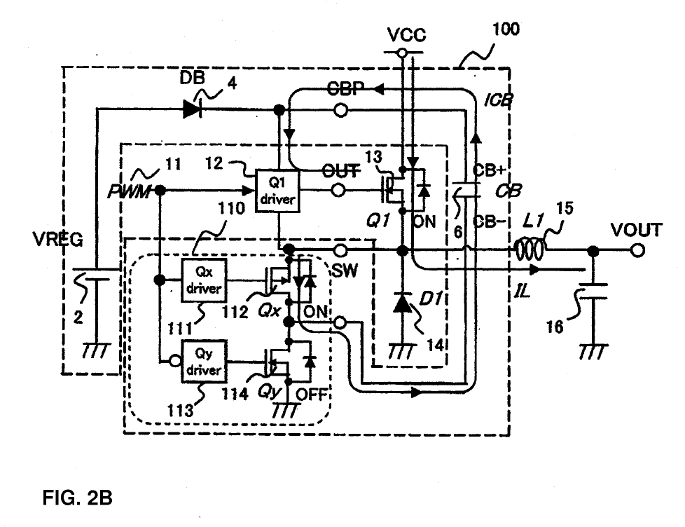

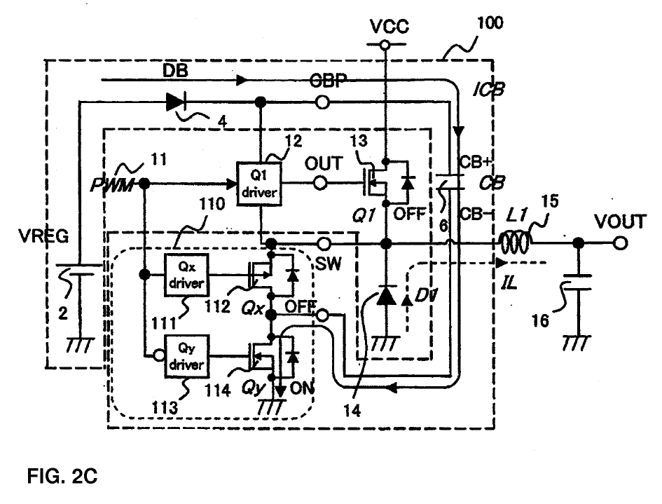

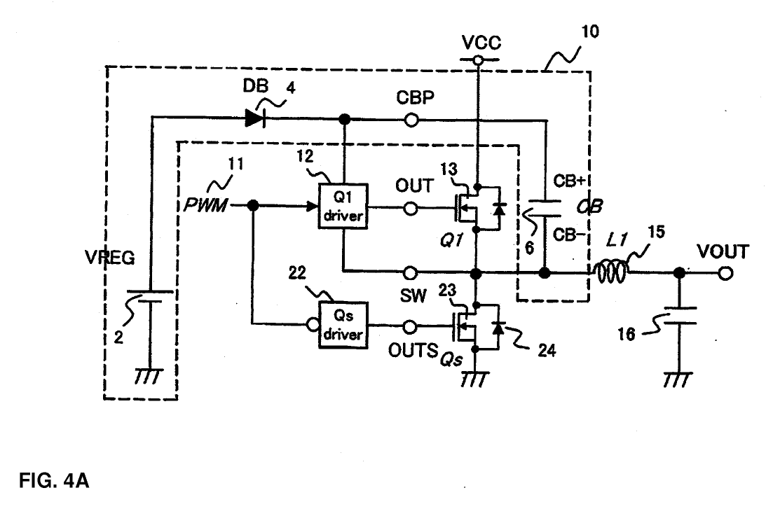

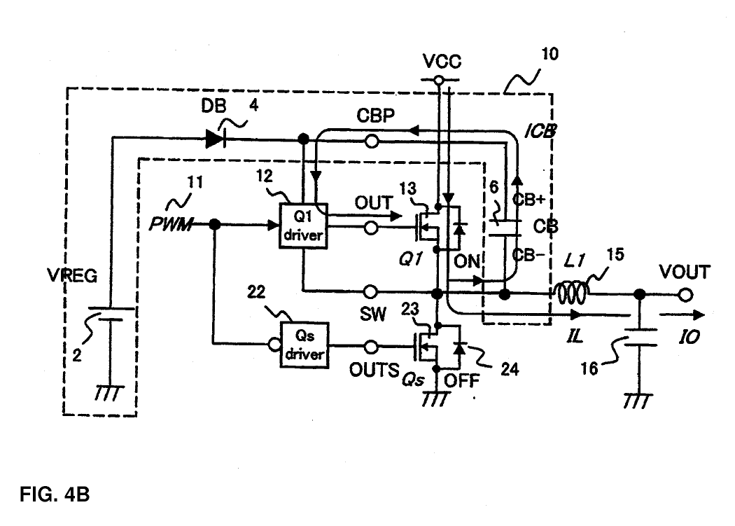

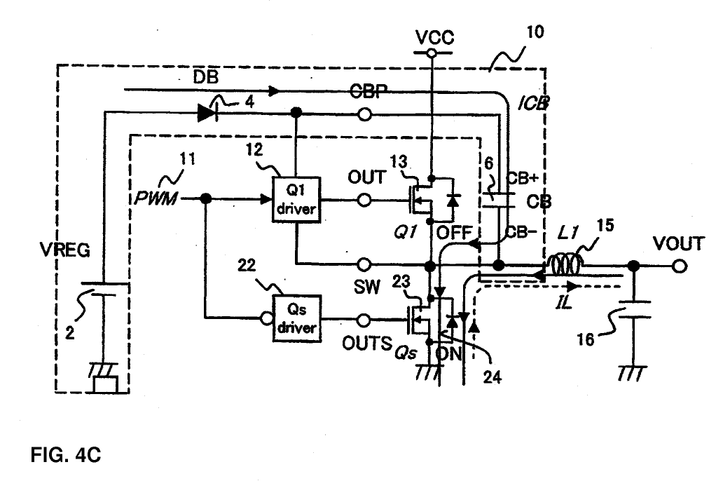

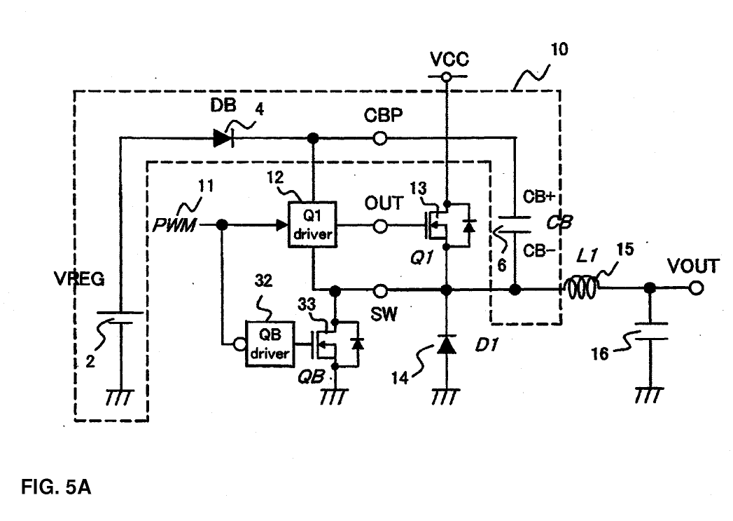

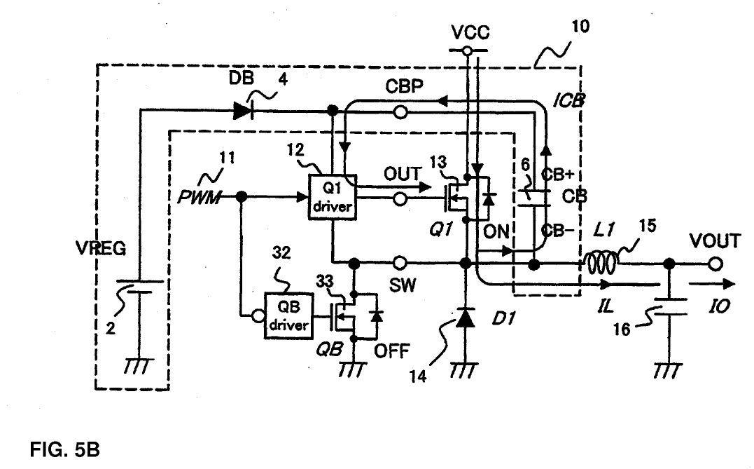

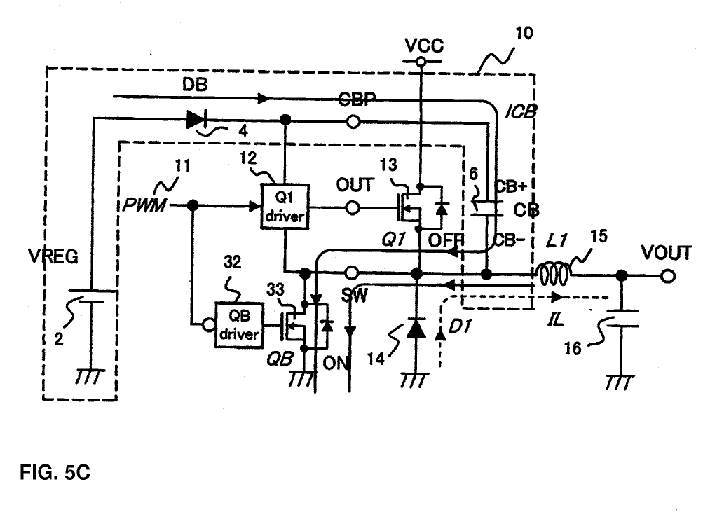

A bootstrap circuit in accordance with the invention, which is the bootstrap circuit 100 shown in FIG. 1A or FIG. 2A, comprises, in addition to the power supply VREG (2), diode D_{B} (4), and capacitor C_{B} (6) used in the bootstrap circuit, which are the constituent components of the bootstrap circuit 10 of the prior art shown in FIG. 4A or FIG. 5A, a configuration which connects the CB-terminal of the capacitor C_{B} (6) used in the bootstrap circuit to the drains of the P-channel MOSFET Qx (112) and the N-channel MOSFET Qy (114), connects the gate of the P-channel MOSFET Qx (112) to the output side of the Qx driver (111) which drives the switch Qx, connects the source of the P-channel MOSFET Qx (112) to the source terminal of the switching device Q₁ (13), and on the other hand connects the gate of the N-channel MOSFET Qy (114) to the output side of the Qy driver (113) which drives the switch Qy, and grounds the source of the N-channel MOSFET Qy (113).

A configuration (capacitor charge/discharge path formation means) 110 is added which, by turning on the switch Qx (112) in synchronization with the on intervals of the switching device Q₁ (13) according to PWM (Pulse Width Modulation) signals 11, the CB-terminal is connected to the source terminal of the switching device Q₁ (13), and by turning on the switch Qy (114) in synchronization with the off intervals of the switching device Q₁ (13) grounds the CB-terminal, so that the CB-terminal of the capacitor C_{B} (6) used in the bootstrap circuit is separated and made independent from the step-down converter circuit. Here, “step-down converter circuit” means the circuit which, by means of the above-described PWM signals 11, drives the switching device Q₁ (13) via the high-side driver (Q₁ driver) 12, and by supplying the inductor current I_{L} from the input voltage VCC to the inductance L₁ (15) during on intervals of the switching device Q₁ (13), stores energy in the inductance L₁ (15), and which discharges stored energy to the load and/or capacitor 16 through the path of the ground potential→inductance L₁ (15)→load during off intervals of the switching device Q₁ (13).

The switch Qs (23) is driven by inverting the PWM signals 11 via the low-side driver (Qs driver) 22, and the switching device Q₁ (13) and switch Qs (23) are turned on and off in a complementary manner, so that both are never turned on simultaneously. Further, the low-side driver (Qs driver) 22 functions to turn off the switch Qs (23) when a protection circuit, not shown, detects backflow of the inductor current I_{L}.

Thus in the bootstrap circuit of this aspect of the invention, capacitor charge/discharge path formation means is provided, and by connecting the CB-terminal of the capacitor C_{B} used in the bootstrap circuit to the step-down converter circuit via this capacitor charge/discharge path formation means, the CB-terminal of the capacitor C_{B} used in the bootstrap circuit can be separated and made independent from the step-down converter circuit. Because the current path to charge the capacitor C_{B} used in the bootstrap circuit is made independent, effects on the step-down converter circuit, that is, the occurrence of power supply efficiency worsening, increases in output ripple, and other side effects, can be avoided. Moreover, the capacitor C_{B} used in the bootstrap circuit can always be charged with stability, regardless of the load state, such as for example when the load is light or there is no load.

FIG. 1A through FIG. 1C show a first embodiment of a step-down converter comprising a bootstrap circuit of an aspect of the invention; in the first embodiment, the invention is applied to a synchronous rectification-type step-down converter. FIG. 1A shows the configuration of the first embodiment of a step-down converter comprising a bootstrap circuit of an aspect of the invention, FIG. 1B explains operation during on intervals of the switching device Q₁ in the step-down converter of the first embodiment shown in FIG. 1A, and FIG. 1C explains operation during off intervals of the switching device Q₁. The first embodiment of course comprises the bootstrap circuit 100 of the aspect of the invention described above. Similarly to the synchronous rectification-type step-down converter of the prior art shown in FIG. 4A through FIG. 4C, in the synchronous rectification-type step-down converter of FIG. 1A to FIG. 1C also, the switching device Q₁ (13) is driven by PWM signals 11 via the driver (Q₁ driver) 12, and by supplying an inductor current I_{L} from the input voltage VCC to the inductance L₁ (15) during on intervals of the switching device Q₁ (13), energy is stored in the inductance L₁ (15), and energy stored in the inductance L₁ (15) is discharged to the load and/or capacitor 16 during off intervals of the switching device Q₁ (13) to realize the step-down converter. Here, the PN junction diode 24 fabricated by semiconductor processes when manufacturing the on-state switch Qs (23) or switch Qs (23) provides a path for current flowing from the inductance L₁ (15) to the load during intervals in which the switching device Q₁ (13) is off, and the capacitor 16 functions as a smoothing capacitor to smooth the output voltage.

During intervals in which the above-described switching device Q₁ (13), which operates according to the PWM signals 11, is turned off, the bootstrap circuit 100 drives the switch Qy (114) by inversion of the PWM signals 11 via the Qy driver (113), as shown in FIG. 1C, so that the switch Qy (114) is turned on and the CB-terminal is grounded in synchronization with the off intervals of the switching device Q₁ (13). By this means, the capacitor C_{B} (6) used in the bootstrap circuit can be charged by the current I_{CB}, via the path from the power supply VREG (2) through the diode D_{B} (4), capacitor C_{B} (6) and switch Qy (114).

Further, during on intervals of the switching device Q₁ (13), by using the PWM signals 11 to drive the switch Qx (112) via the Qx driver (111) as shown in FIG. 1B, to turn on the switch Qx (112) in synchronization with the on intervals of the switching device Q₁ (13), the CB-terminal is connected to the source terminal of the switching device Q₁ (13). By this means, the gate terminals of the high-side driver (Q₁ driver) 12 and switching device Q₁ (13) are driven by the voltage resulting by adding the voltage to which the capacitor C_{B} (6) used in the bootstrap circuit is charged and the input voltage VCC, and the switching device Q₁ (13) can be turned on. By turning on the switching device Q₁ (13), the inductor current I_{L} from the input voltage VCC is supplied to the inductor L₁ (15), and energy can be stored in the inductance L₁ (15). The switches Qx (112) and Qy (114) are turned on and off in a complementary manner, so that both are never turned on simultaneously.

In this first embodiment of a step-down converter comprising a bootstrap circuit of an aspect of this invention, a bootstrap circuit is comprised having capacitor charge/discharge path formation mechanism or means, and by connecting the CB-terminal of the capacitor C_{B} used in the bootstrap circuit to the step-down converter circuit via the capacitor charge/discharge path formation mechanism, the current path to charge the capacitor C_{B} used in the bootstrap circuit can be made independent. As a result, effects on the step-down converter circuit, that is, the occurrence of power supply efficiency worsening, increases in output ripple, and other side effects, can be avoided, so that stable operation and improved power supply efficiency of the step-down converter circuit can be expected. Moreover, the capacitor C_{B} used in the bootstrap circuit can always be charged with stability, regardless of the load state, such as for example when the load is light or there is no load.

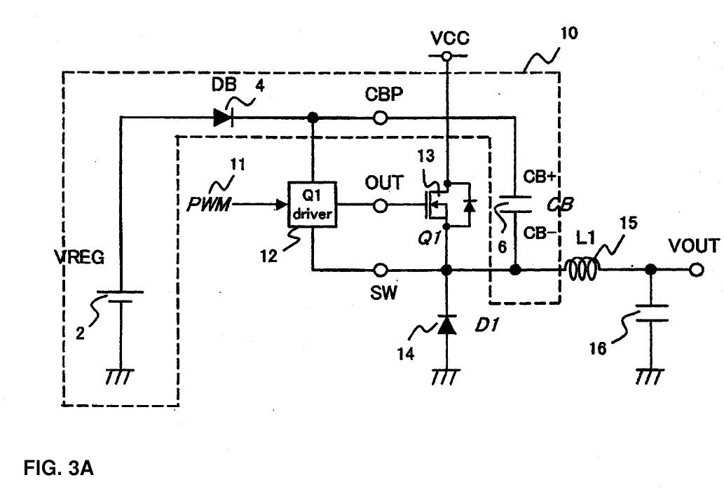

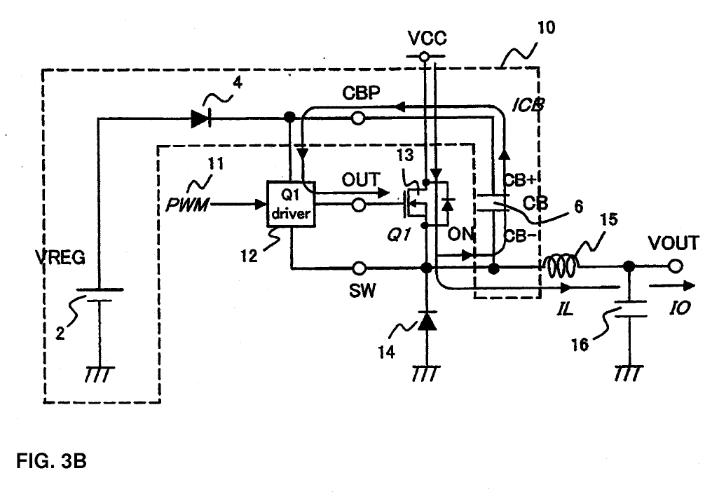

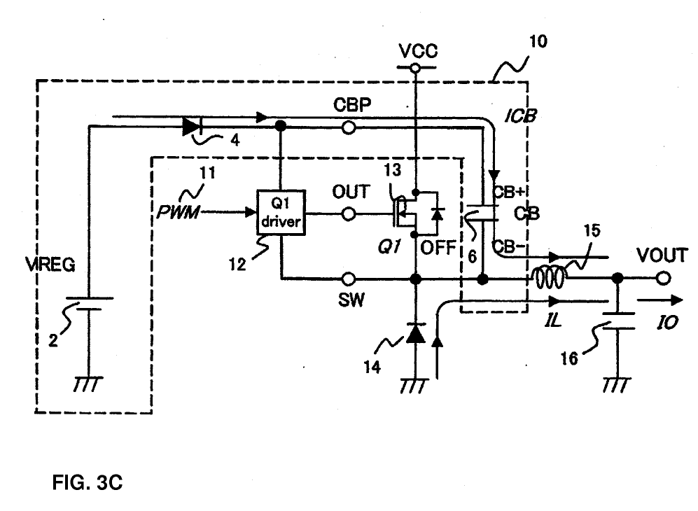

FIG. 2A through FIG. 2C show a second embodiment of a step-down converter comprising the bootstrap circuit of an aspect of the invention; in the second embodiment, the invention is applied to a diode rectification-type step-down converter. FIG. 2A shows the configuration of the second embodiment of the step-down converter comprising the bootstrap circuit of an aspect of the invention, FIG. 2B explains operation during on intervals of the switching device Q₁ in the step-down converter of the second embodiment shown in FIG. 2A, and FIG. 2C explains operation during off intervals of the switching device Q₁. The second embodiment of course comprises the bootstrap circuit 100 of the aspect of the invention described above. Similarly to FIG. 3A through FIG. 3C or to the diode rectification-type step-down converter of the prior art shown in FIG. 5A through FIG. 5C, in the diode rectification-type step-down converter of FIG. 2A to FIG. 2C also, the switching device Q₁ (13) is driven by PWM signals 11 via the driver (Q₁ driver) 12, and by supplying an inductor current I_{L} from the input voltage VCC to the inductance L₁ (15) during on intervals of the switching device Q₁ (13), energy is stored in the inductance L₁ (15), and energy stored in the inductance L₁ (15) is discharged to the load and/or capacitor 16 during off intervals of the switching device Q₁ (13) to realize the step-down converter. Here, the diode D₁ (14) provides a path for current flowing from the inductance L₁ (15) to the load during intervals in which the switching device Q₁ (13) is off, and the capacitor 16 functions as a smoothing capacitor which smoothes the output voltage.

During intervals in which the above-described switching device Q₁ (13), which operates according to the PWM signals 11, is turned off, the bootstrap circuit 100 drives the switch Qx (112) by inversion of the PWM signals 11 via the Qx driver (111), as shown in FIG. 2C, so that the switch Qy (114) is turned on and the CB-terminal is grounded in synchronization with the off intervals of the switching device Q₁ (13). By this means, the capacitor C_{B} (6) used in the bootstrap circuit can be charged by the current I_{CB}, via the path from the power supply VREG (2) through the diode D_{B} (4), capacitor C_{B} (6) and switch Qy (114).

Further, during on intervals of the switching device Q₁ (13), by using the PWM signals 11 to drive the switch Qx (112) via the Qx driver (111) as shown in FIG. 2B, to turn on the switch Qx (112) in synchronization with the on intervals of the switching device Q₁ (13), the CB-terminal is connected to the source terminal of the switching device Q₁ (13). By this means, the gate terminals of the high-side driver (Q1 driver) 12 and switching device Q₁ (13) are driven by the voltage resulting by adding the voltage to which the capacitor C_{B} (6) used in the bootstrap circuit is charged and the input voltage VCC, and the switching device Q₁ (13) can be turned on. By turning on the switching device Q₁ (13), the inductor current I_{L} from the input voltage VCC is supplied to the inductor L₁ (15), and energy can be stored in the inductance L₁ (15). Further, the switches Qx (112) and Qy (114) are turned on and off in a complementary manner, so that both are never turned on simultaneously.

In this second embodiment of a step-down converter comprising a bootstrap circuit of an aspect of this invention, a bootstrap circuit is comprised having capacitor charge/discharge path formation mechanism or means, and by connecting the CB-terminal of the capacitor C_{B} used in the bootstrap circuit to the step-down converter circuit via the capacitor charge/discharge path formation mechanism, the current path to charge the capacitor C_{B} used in the bootstrap circuit can be made independent. As a result, effects on the step-down converter circuit, that is, the occurrence of power supply efficiency worsening, increases in output ripple, and other side effects, can be avoided, so that stable operation and improved power supply efficiency of the step-down converter circuit can be expected. Moreover, the capacitor C_{B} used in the bootstrap circuit can always be charged with stability, regardless of the load state, such as for example when the load is light or there is no load.

The invention has been described with reference to certain preferred embodiments thereof. It will be understood, however, that modifications and variations are possible within the scope of the appended claims.

This application is based on, and claims priority to, Japanese Patent Application No: 2007-277022, filed on Oct. 24, 2007. The disclosure of the priority application, in its entirety, including the drawings, claims, and the specification thereof, is incorporated herein by reference.

What is claimed is:

1. A bootstrap circuit comprising:
a capacitor which steps up a power supply voltage of a driver to an input voltage or higher, in order to perform switching control by applying a voltage from the driver to a gate of a switching device employing an N-channel MOSFET having a drain to which the input voltage is supplied; and
a capacitor charge/discharge path formation mechanism, which forms, independently of a step-down converter circuit, a charge/discharge path for charging the capacitor in synchronization with an off state of the switching device, and for discharging the capacitor in synchronization with an on state of the switching device for application as the power supply voltage to the driver.

2. The bootstrap circuit according to claim 1, wherein the capacitor charge/discharge path formation mechanism includes a first switch, which connects a ground-side terminal of the capacitor to ground in order to form a charge path for the capacitor in synchronization with the off state of the switching device, and a second switch, which connects the ground-side terminal of the capacitor to a source terminal of the switching device in order to form a discharge path for the capacitor in synchronization with the on state of the switching device.

3. The bootstrap circuit according to claim 2, wherein an N-channel MOSFET is used in the first switch, a P-channel MOSFET is used in the second switch, and a drain of the N-channel MOSFET and a drain of the P-channel MOSFET are connected to the ground-side terminal of the capacitor.

4. A step-down converter, using the bootstrap circuit according to any one of claims 1 through 3 in the power supply of a driver which drives a switching device that uses an N-channel MOSFET on the high side.

5. A synchronous rectification-type step-down converter, comprising a synchronous rectification-type step-down converter constituted using the bootstrap circuit according to any one of claims 1 through 3 in the power supply of a driver which drives a switching device that uses an N-channel MOSFET on the high side.

6. A diode rectification-type step-down converter, comprising a diode rectification-type step-down converter constituted using the bootstrap circuit according to any one of claims 1 through 3 in the power supply of a driver which drives a switching device that uses an N-channel MOSFET on the high side.
